(19) United States
(12) Patent Application Publication
(10) Pub. No.: US 2024/0180079 A1
(43) Pub. Date: Jun. 6, 2024

(54) COVER FOR A CATCHING BAG OF A LAWN AND YARD MACHINE

(71) Applicant: Michael A Gailloux, Leawood, KS (US)

(72) Inventor: Michael A Gailloux, Leawood, KS (US)

(21) Appl. No.: 18/061,461

(22) Filed: Dec. 3, 2022

(51) Int. Cl. A01D 43/063

(52) U.S. Cl. CPC A01D 43/063

(57) ABSTRACT

This invention discloses a cover for a catching bag of a lawn and yard machine that provides air filtration for air exiting the catching bag. With the use of the cover, air quality is improved for the operator of the machine and the environment.

### FIELD OF THE INVENTION

The invention relates to covers of catching bags of organic matter attached to lawn and yard machines. Lawn and yard machines include walk-behind mowers, riding mowers, leaf vacuums and other similar machines. The cover provides air filtration to air exiting the catching bag to remove debris and fine particles from the air around the machine, while the machine is in operation.

### BACKGROUND OF THE INVENTION

Maintaining real estate often contains work related to the maintenance of plants upon the ground. Often a powered mowing machine is used to cut grass and plants which are in place to beautify the environment or naturally living. The most common mowing machines are the walk-behind powered lawn mower or a version which the operator rides upon, often referred to as the riding mower. The self-powered mowing machine is also present in market.

Powered mowing machines can operate with or without a grass catching bag. When a mowing machine operates the cutting blade spins at about 3000 revolutions per minute. This blade motion creates air movement inside of the mowing machine and the air is guided to flow through the exit chute and into the catching bag. The air contains any particles that can be affected by the air movement. When mowing a standard grass lawn, it is common to find freshly cut grass and any other natural material present within the lawn and landscape.

The grass catching bag is designed to block the significant pieces of material from exiting the bag while allowing air to freely pass through the bag into the environment around the machine. When the user wishes to empty the grass bag, it can be removed from the mowing machine, emptied, and reinstalled.

The term catching bag will be used to represent the variety of grass and material catching bags on powered yard and lawn machines. The catching bags are designed to withstand wear and use over long periods of time and varieties of conditions. They are made of permeable materials that will collect the cut plant material while permitting air to flow out of the bag. The catching bag materials are selected for their characteristics to allow the air to flow freely and to not clog. For the current designs of catching bags, the air that passes through the grass catching bag into the environment around the machine contains debris, pollen, and allergens. The primary reasons for the manufacturer to not select a material that would filter air particles fine enough to capture more debris, pollen, and allergens is that this material may not be durable over long periods of time. This also is not a prominent feature used to sell the machine and would add to the manufacturing costs.

When operating a powered lawn and yard machine, the debris, pollen and allergens land upon the operator's body and eyes and are inhaled into the lungs of the operator. This is not a desirable outcome of using the machine and has adverse health benefits for the operator.

The present invention reduces allergens, pollens and particles in the air that affect humans when operating powered lawn and yard machines. The goal of this invention is to enable individuals who suffer from asthma or allergies or seek to perform lawn maintenance tasks more safely.

Current lawn and yard maintenance catching bags do not filter the air exiting the catching bag to improve air quality for the operator. This invention details methods to remove small air particles, notably allergens and pollen, from the air exiting a grass catching bag to provide the operator a healthier environment.

### SUMMARY OF THE INVENTION

The invention is a cover for a catching bag that is for a lawn and yard maintenance machines. The cover can be crafted of non-permeable material and has at least one air filter opening that contains an air filter. In another embodiment, the cover can be made almost entirely of air filtration material. Both embodiments are describing a cover that filters allergens and pollen from the air exiting the catching bag to improve air quality around the mowing machine for human operators.

In operation, an air filter is inserted into the air filter holder. The grass catching bag of a lawn mowing machine is inserted into the cover. The cover and catching bag are then installed upon the lawn mowing machine. The air filter opening has a flap that is mounted to the cover on the top side of the opening to protect the air filter and allow air to flow through the cover in a downward direction, away from the user. The redirection of the airflow exiting the cover aids in reducing the air pollutants for the machine operator. The air filter is replaceable.

### BRIEF DESCRIPTION OF THE DRAWINGS

FIG. 1 is a perspective view of a representative embodiment of the present invention.

FIG. 2 is a partial perspective view of the inside portion of a representative embodiment of the present invention. Shown is the air filter opening, the air filter holder and how the air filter installs into the air filter holder.

FIG. 3 is a perspective view of an alternate embodiment of the present invention showing a cover made primarily of air filtering material.

FIG. 4 is a perspective view of a representative embodiment of the present invention with a catching bag inserted within.

FIG. 5 is a drawing of a lawn maintenance system with an alternate embodiment of the present invention; a cover made primarily of air filtering material.

FIG. 6 is a perspective view of a representative embodiment of the present invention. Cover has emblem and colored panels.

### DETAILED DESCRIPTION OF THE PREFERRED EMBODIMENT

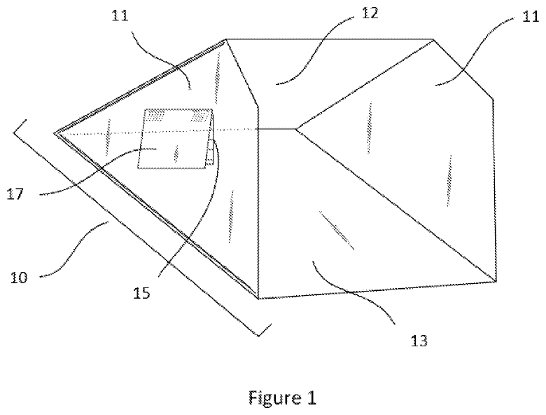

Referring to FIG. 1, a representative embodiment of the present invention. A cover 10 for a catching bag of a lawn and yard maintenance machine. A pair of side panels 11, a top panel 12 connected to the pair of side panels and a bottom panel 13 connected to the top panel at one end and the pair of side panels. The panels are constructed from non-permeable material. A removable air filter 15 with a filter cover 17 that extends over the air filter.

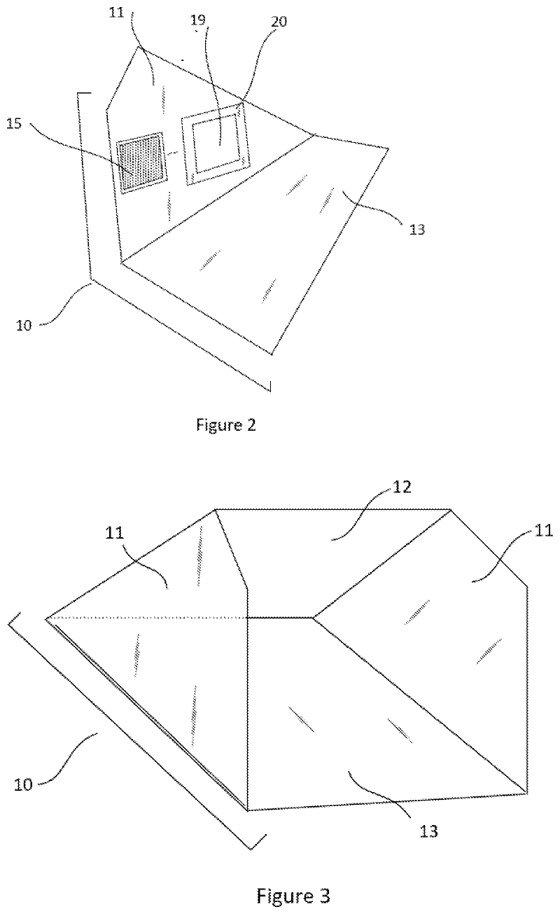

Referring to FIG. 2 is a partial perspective view of the inside portion of a representative embodiment of the present invention. The cover contains a removable air filter 15 to remove the debris and fine particles from the air prior to exiting the cover 10. Air filter 15 slides into the air filter holder 20, which is attached to the cover on the top, bottom and one side. When the air filter is inserted into the air filter holder 20 it covers the air filter opening 19. Side panel 11 connected to bottom panel 13.

Referring to FIG. 3, is a perspective view of an alternate embodiment of the present invention showing a cover made primarily of air filtering material. In operation, a catching bag is placed inside cover 10. A pair of side panels 11 of the cover, a top panel 12 connected to the pair of side panels and a bottom panel 13 connected to the top panel at one end and the pair of side panels.

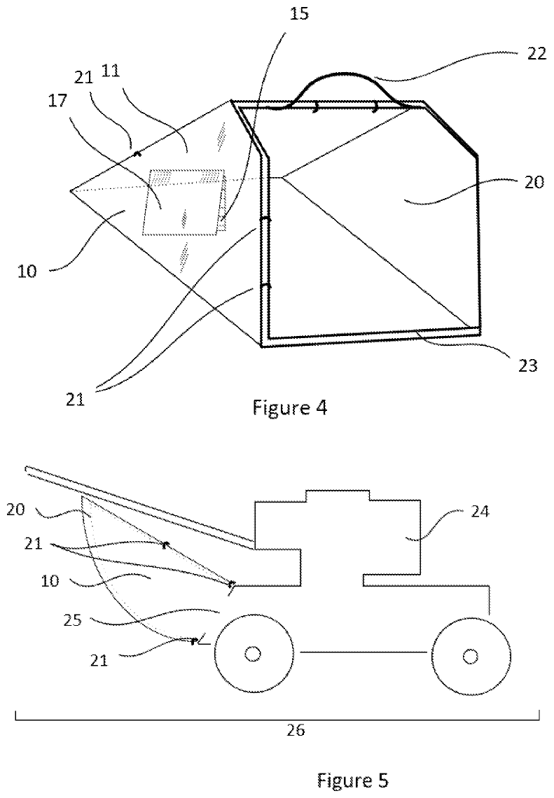

Referring to FIG. 4, a representative embodiment of the present invention. This image is showing the catching bag 20, inserted into the cover 10. The cover contains the air escaping the catching bag and removes the debris, pollen, and allergens from the air by guiding the air through air filter 15 which is on the side panel 11. Cover contains air filter cover 17 protecting air filter 15. Cover attached to catching bag frame 23 of the lawn and yard maintenance machine with clips 21. A catching bag handle shown 22.

Referring to FIG. 5, a view of an alternate embodiment of the present invention installed upon a mowing machine. This embodiment is nearly made entirely of a air filtration material to provide air particle filtration to minimize debris, allergens and particles exiting the catching bag. A lawn maintenance system 26 comprising of a powered lawn and yard maintenance machine 24 having an opening 25 for discharging organic yard matter during operation. A catching bag 20 that is inside of the cover 10 coupled to the opening 25 for collecting cut yard matter. The cover and the catching bag secured to the lawn and yard maintenance machine proximate to the opening 25 with clips 21.

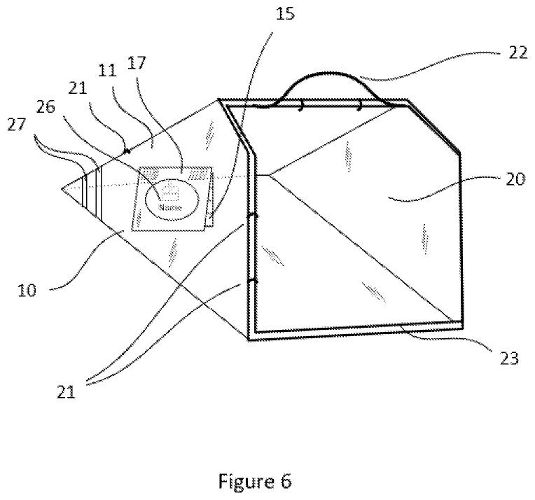

Referring to FIG. 6 is a perspective view of a representative embodiment of the present invention. Cover has emblem 26 and striped colored panels 27 for a branded organization, sports team or individual desire. The emblem or logo and stripes can be printed, stitched, adhered, or painted on the cover 10. The striped colored panels 27 are of a color that is different than cover 10. Catching bag 20, inserted into the cover 10. The cover contains the air escaping the catching bag and removes the debris, pollen, and allergens from the air by guiding the air through air filter 15 which is on the side panel 11. Cover contains air filter cover 17 protecting air filter 15. Cover attached to catching bag frame 23 of the lawn and yard maintenance machine with clips 21. A catching bag handle shown 22.

The scope of the invention stated could also be achieved with various modifications. The stated terms and diagrams used in the preceding specification have been used herein as terms of description and not of limitation. There is no intention in the use of such terms to exclude equivalents of the features shown and described.

We claim:

1. A cover for a catching bag of a lawn and yard machine comprising:
A pair of side panels;
a top panel connected to the pair of side panels;
a bottom panel connected to the top panel at one end and the pair of side panels; and an air filter opening having an air filter;
wherein the air filter removes the debris and fine particles from the air that has left the lawn and yard maintenance machine catching bag.

2. The cover of claim 1 wherein the air filter opening further comprises an air filter holder.

3. The cover of claim 1, wherein the air filter is removable.

4. The cover of claim 1, further comprising at least one air filter cover extending over the air filter opening and air filter.

5. The cover of claim 4, wherein the air filter cover exhausts air away from the operator.

6. The cover of claim 1, wherein the cover is secured to the lawn and yard maintenance machine with a plurality of clips.

7. The cover of claim 1, wherein the side panels, the top panel and the bottom panel are each fabricated from a non-permeable material.

8. The cover of claim 1, wherein the cover contains at least one replaceable air filter to remove the debris and fine particles from the air prior to exiting the cover.

9. A cover surrounding a catching bag on a lawn and yard maintenance machine, the cover comprised entirely of a material to provide air particle filtration to minimize debris, allergens and particles exiting the catching bag.

10. A cover surrounding a catching bag of claim 9, wherein the catching bag slides inside the cover.

11. The cover for the catching bag of claim 9, wherein the cover is secured to the catching bag frame of the lawn and yard maintenance machine with a plurality of clips.

12. The cover for the catching bag of claim 1, comprised of permeable and non-permeable material.

13. A lawn maintenance system comprising: a powered lawn and yard maintenance machine having an opening for discharging organic yard matter during operation;
a bag coupled to the opening for collecting cut yard matter;
a cover encompassing the bag, where the cover and the bag are secured to the lawn and yard maintenance machine proximate to the opening.

14. The system of claim 13 wherein the cover is fabricated from air filtration material.

15. The system of claim 13, wherein the cover further comprises an air filter opening.

16. The system of claim 15 wherein the air filter opening further comprises an air filter holder.

17. The system of claim 16 wherein an air filter is removably secured in the air filter holder.

18. The system of claim 17 wherein the exterior of the cover is comprised of material of two colors.

19. The system of claim 18 wherein the exterior of the cover further comprises a sewn or painted or stitched or adhered emblem.
